(19) United States
(12) Patent Application Publication
(10) Pub. No.: US 2026/0116658 A1
(43) Pub. Date: Apr. 30, 2026

(54) SYSTEMS AND METHODS FOR OPERATING ACTUATORS OF A REFUSE VEHICLE

(71) Applicant: Oshkosh Corporation, Oshkosh, WI (US)

(72) Inventors: Cole Adams, Oshkosh, WI (US); Chris Rukas, Oshkosh, WI (US); Wesley Van Pelt, Oshkosh, WI (US)

(73) Assignee: Oshkosh Corporation, Oshkosh, WI (US)

(21) Appl. No.: 19/368,644

(22) Filed: Oct. 24, 2025

Related U.S. Application Data
(60) Provisional application No. 63/712,263, filed on Oct. 25, 2024.

(51) Int. Cl. B65F 3/04; B65F 3/02; B65F 3/08

(52) U.S. Cl. CPC B65F 3/041; B65F 3/08; B65F 2003/0223; B65F 2003/025; B65F 2003/0279

(57) ABSTRACT

A refuse vehicle includes a lift apparatus configured to collect refuse, one or more sensors, and one or more processing circuits. The lift apparatus includes a first movable body, a first actuator configured to move the first movable body, a second movable body, and a second actuator configured to move the second movable body. The one or more sensors are configured to generate sensor data associated with a first displacement of the first movable body and a second displacement of the second movable body. The one or more processing circuits are configured to operate the first actuator and the second actuator with a first speed, acquire the sensor data, and responsive to a difference between the first displacement of the first movable body and the second displacement of the second movable body being greater than a difference threshold, operate the first actuator or the second actuator with a second speed.

### CROSS-REFERENCE TO RELATED APPLICATIONS

This application claims the benefit of and priority to U.S. Provisional Patent Application No. 63/712,263 filed Oct. 25, 2024, the entire contents of which are hereby incorporated by reference herein.

### BACKGROUND

The present disclosure generally relates to the field of refuse vehicles. More specifically, the present disclosure relates to control systems for refuse vehicles.

### SUMMARY

One exemplary embodiment of the present disclosure relates to a refuse vehicle. The refuse vehicle includes a chassis, a body coupled to the chassis, a lift apparatus coupled to at least one of the chassis or the body and configured to collect refuse, one or more sensors, and one or more processing circuits communicably coupled to the one or more sensors. The lift apparatus includes a first movable body, a first actuator configured to move the first movable body, a second movable body associated with the first movable body, and a second actuator configured to move the second movable body. The one or more sensors are configured to generate sensor data associated with a first displacement of the first movable body and a second displacement of the second movable body. The one or more processing circuits are configured to operate the first actuator and the second actuator with a first speed, acquire, from the one or more sensors, the sensor data, and responsive to a difference between the first displacement of the first movable body and the second displacement of the second movable body being greater than a difference threshold, operate the first actuator or the second actuator with a second speed. The second speed is different from the first speed.

Another exemplary embodiment of the present disclosure relates to a refuse vehicle. The refuse vehicle includes a chassis, a body coupled to the chassis, a lift apparatus coupled to at least one of the chassis or the body and configured to collect refuse, a first sensor, a second sensor, and one or more processing circuits communicably coupled to the first sensor and the second sensor. The lift apparatus includes a first movable body, a first actuator configured to move the first movable body, a second movable body associated with the first movable body, and a second actuator configured to move the second movable body. The first sensor is configured to generate first sensor data associated with a first displacement of the first movable body. the second sensor is configured to generate second sensor data associated with a second displacement of the second movable body. The one or more processing circuits are configured to operate the first actuator and the second actuator with a first speed, acquire, from the first sensor, the first sensor data, acquire, from the second sensor, the second sensor data, and responsive to the first displacement of the first movable body being greater than the second displacement of the second movable body, operate the first actuator with a second speed. The second speed is slower than the first speed.

Yet another exemplary embodiment of the present disclosure relates to a method of operating a plurality of corresponding actuators of a refuse vehicle. The method includes operating a first actuator of the plurality of corresponding actuators with a first speed to move a first movable body, operating a second actuator of the plurality of corresponding actuators with a second speed to move a second movable body, acquiring, from one or more sensors associated with the plurality of corresponding actuators, sensor data associated with a first displacement of the first movable body and a second displacement of the second movable body, and responsive to a difference between the first displacement of the first movable body and the second displacement of the second movable body being greater than a difference threshold, operating the first actuator or the second actuator with a second speed. The second speed is different from the first speed.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a perspective view of a lift system of the side-loading refuse vehicle of FIG. 3, according to an exemplary embodiment;

FIG. 5 is a top view of a grabber assembly of the lift system of FIG. 4, according to an exemplary embodiment;

FIG. 6 is a block diagram of the grabber assembly of FIG. 5, according to an exemplary embodiment;

FIG. 7 is a block diagram of a control system for any of the refuse vehicles of FIGS. 1-3, according to an exemplary embodiment; and

FIG. 8 is a flow chart of a method for operating at least two associated actuators of any of the refuse vehicles of FIGS. 1-3, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the Figures, a refuse vehicle includes a controller configured synchronize operation of at least two actuators that are configured to drive movable bodies of the refuse vehicle. The controller may derate a speed of at least one of the at least two actuators to synchronize displacement rates of displacements of the movable bodies driven by the actuators. For example, the controller may operate a first grabber arm actuator to drive a first grabber arm and a second grabber arm actuator to drive a second grabber arm in order to grasp a refuse container. The controller may operate the first grabber arm actuator and the second grabber arm actuator with a target speed to drive the first grabber arm and the second grabber arm. The controller may receive first sensor data corresponding to a first displacement of the first grabber arm and second sensor data corresponding to a second displacement of the second grabber arm. However, while the controller is operating the first grabber arm actuator and the second grabber arm actuator with the target speed, the first grabber arm actuator may be operated with a speed that is faster or slower than the second grabber arm actuator, resulting in the first displacement of the first grabber arm being greater than or less than the second displacement of the second grabber arm such that the first grabber arm and the second grabber arm are operated out of sync with one another. Responsive to the first displacement being greater than the second displacement, the controller may operate the first grabber arm actuator with a derated speed that is slower than the target speed such that a first displacement rate of the first displacement of the first grabber arm is equal to a second displacement rate of the second displacement of the second grabber arm to operate the first grabber arm and the second grabber arm in sync.

As a result, the controller may operate the first grabber arm and the second grabber arm may contact a refuse container while the first grabber arm and the second grabber arm are moving at the same speed, which may improve a grasping operation of the first grabber arm and the second grabber arm around the refuse container, which can reduce the risk of incomplete engagement and/or tipping of the refuse container, and provide more uniform forces across the refuse container during refuse collection operations.

### Refuse Vehicle

### Front-Loading Configuration

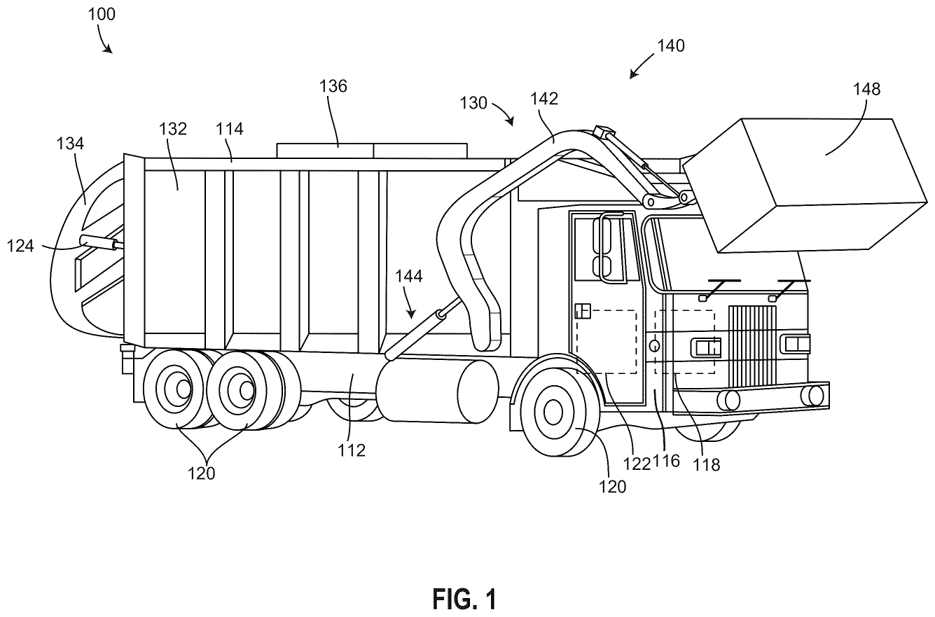

Referring to FIG. 1, a vehicle, shown as refuse vehicle 100 (e.g., a garbage truck, a waste collection truck, a sanitation truck, etc.), is shown that is configured to collect and store refuse along a collection route. In the embodiment of FIG. 1, the refuse vehicle 100 is configured as a front-loading refuse vehicle. The refuse vehicle 100 includes a chassis, shown as frame 112; a body assembly, shown as body 114, coupled to the frame 112 (e.g., at a rear end thereof, etc.); and a cab, shown as cab 116, coupled to the frame 112 (e.g., at a front end thereof, etc.). The cab 116 may include various components to facilitate operation of the refuse vehicle 100 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 100 includes a prime mover, shown as engine 118, coupled to the frame 112 at a position beneath the cab 116. The engine 118 is configured to provide power to tractive elements, shown as tractive elements 120, and/or to other systems of the refuse vehicle 100 (e.g., a pneumatic system, a hydraulic system, etc.). The engine 118 may be configured to utilize one or more of a variety of fuels (e.g., gasoline, diesel, bio-diesel, ethanol, natural gas, etc.), according to various exemplary embodiments. The fuel may be stored in a tank 128 (e.g., a vessel, a container, a capsule, etc.) that is fluidly coupled with the engine 118 through one or more fuel lines.

According to an alternative embodiment, the engine 118 additionally or alternatively includes one or more electric motors coupled to the frame 112 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 100. The engine 118 may transfer output torque to or drive the tractive elements 120 (e.g., wheels, wheel assemblies, etc.) of the refuse vehicle 100 through a transmission. The engine 118, the transmission 122, and one or more shafts, axles, gearboxes, etc., may define a driveline of the refuse vehicle 100.

According to an exemplary embodiment, the refuse vehicle 100 is configured to transport refuse from various waste receptacles within a municipality to a storage and/or processing facility (e.g., a landfill, an incineration facility, a recycling facility, etc.). As shown in FIG. 1, the body 114 includes a plurality of panels, shown as panels 132, a tailgate 134, and a cover 136. The panels 132, the tailgate 134, and the cover 136 define a collection chamber (e.g., hopper, etc.), shown as refuse compartment 130. Loose refuse may be placed into the refuse compartment 130 where it may thereafter be compacted. The refuse compartment 130 may provide temporary storage for refuse during transport to a waste disposal site and/or a recycling facility. In some embodiments, at least a portion of the body 114 and the refuse compartment 130 extend in front of the cab 116. According to the embodiment shown in FIG. 1, the body 114 and the refuse compartment 130 are positioned behind the cab 116. In some embodiments, the refuse compartment 130 includes a hopper volume and a storage volume. Refuse may be initially loaded into the hopper volume and thereafter transferred and/or compacted into the storage volume. According to an exemplary embodiment, the hopper volume is positioned forward of the cab 116 (e.g., refuse is loaded into a portion of the refuse compartment 130 in front of the cab 116, a front-loading refuse vehicle, etc.). In other embodiments, the hopper volume is positioned between the storage volume and the cab 116 (e.g., refuse is loaded into a portion of the refuse compartment 130 behind the cab 116 and stored in a portion further toward the rear of the refuse compartment 130). In yet other embodiments, the storage volume is positioned between the hopper volume and the cab 116 (e.g., a rear-loading refuse vehicle, etc.).

The tailgate 134 may be hingedly or pivotally coupled with the body 114 at a rear end of the body 114 (e.g., opposite the cab 116). The tailgate 134 may be driven to rotate between an open position and a closed position by tailgate actuators 124. The refuse compartment 130 may be hingedly or pivotally coupled with the frame 112 such that the refuse compartment 130 can be driven to raise or lower while the tailgate 134 is open in order to dump contents of the refuse compartment 130 at a landfill. The refuse compartment 130 may include a packer assembly (e.g., a compaction apparatus) positioned therein that is configured to compact loose refuse.

Referring still to FIG. 1, the refuse vehicle 100 includes a first lift mechanism or system (e.g., a front-loading lift assembly, etc.), shown as lift assembly 140. The lift assembly 140 includes a pair of arms, shown as lift arms 142, coupled to at least one of the frame 112 or the body 114 on either side of the refuse vehicle 100 such that the lift arms 142 extend forward of the cab 116 (e.g., a front-loading refuse vehicle, etc.). The lift arms 142 may be rotatably coupled to frame 112 with a pivot (e.g., a lug, a shaft, etc.). The lift assembly 140 includes first actuators, shown as lift arm actuators 144 (e.g., hydraulic cylinders, etc.), coupled to the frame 112 and the lift arms 142. The lift arm actuators 144 are positioned such that extension and retraction thereof rotates the lift arms 142 about an axis extending through the pivot, according to an exemplary embodiment. The lift arms 142 may be removably coupled to a container, shown as refuse container 148 in FIG. 1. The lift arms 142 are configured to be driven to pivot by lift arm actuators 144 to lift and empty the refuse container 148 into the hopper volume for compaction and storage. The lift arms 142 may be coupled with a pair of forks or elongated members that are configured to removably couple with the refuse container 148 so that the refuse container 148 can be lifted and emptied. The refuse container 148 may be similar to the container attachment 200 as described in greater detail in U.S. application Ser. No. 17/558,183, filed Dec. 12, 2021, the entire disclosure of which is incorporated by reference herein.

### Rear-Loading Configuration

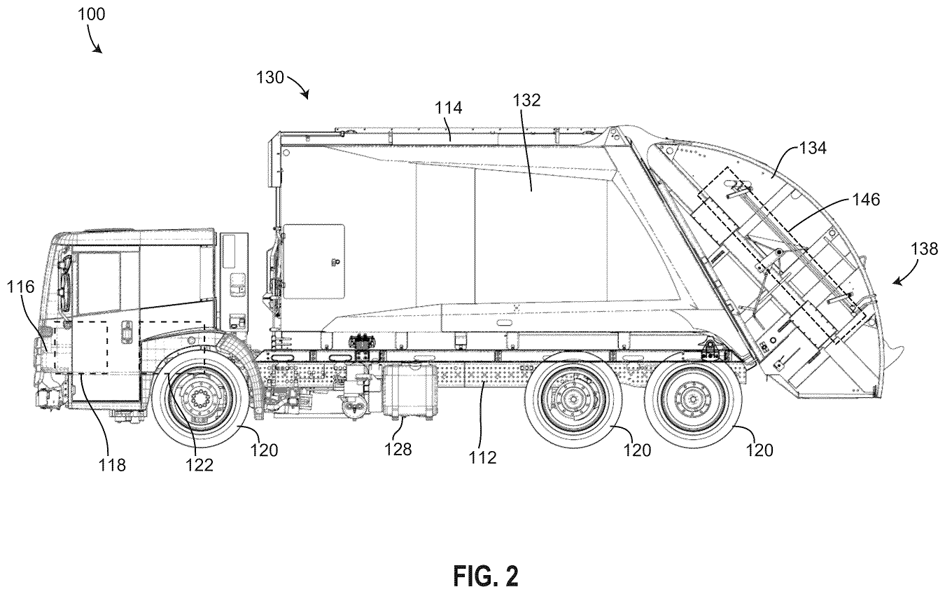

As shown in FIG. 2, the refuse vehicle 100 may be configured as a rear-loading refuse vehicle, according to some embodiments. In the rear-loading embodiment of the refuse vehicle 100, the tailgate 134 defines an opening 138 through which loose refuse may be loaded into the refuse compartment 130. The tailgate 134 may also include a packer 146 (e.g., a packing assembly, a compaction apparatus, a claw, a hinged member, etc.) that is configured to draw refuse into the refuse compartment 130 for storage. Similar to the embodiment of the refuse vehicle 100 described in FIG. 1 above, the tailgate 134 may be hingedly coupled with the refuse compartment 130 such that the tailgate 134 can be opened or closed during a dumping operation.

### Side-Loading Configuration

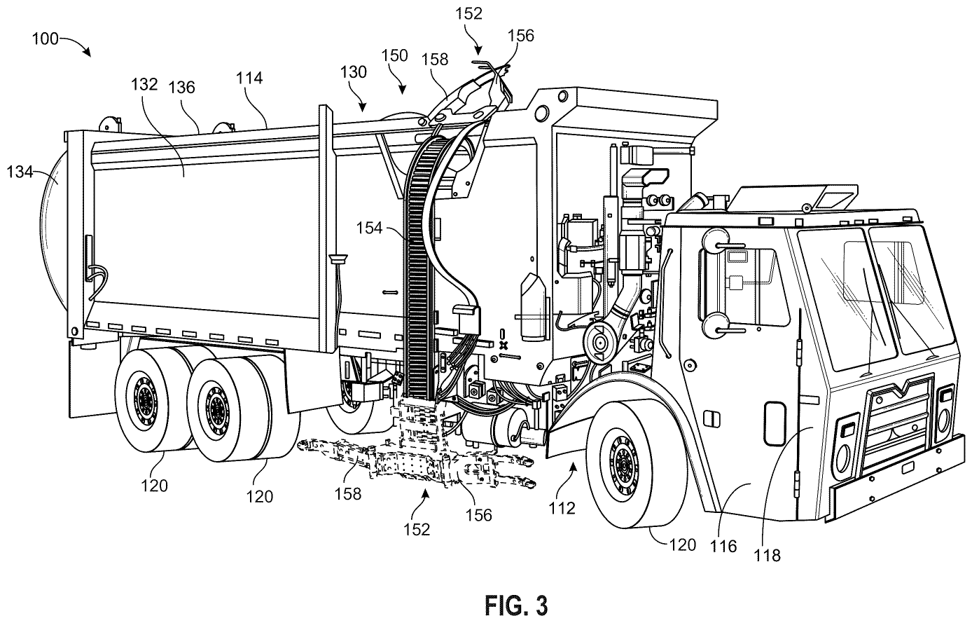

As shown in FIG. 3, the refuse vehicle 100 may be configured as a side-loading refuse vehicle (e.g., a zero radius side-loading refuse vehicle). The refuse vehicle 100 includes first lift mechanism or system, shown as lift assembly 150. Lift assembly 150 includes a grabber assembly, shown as grabber assembly 152, movably coupled to a track, shown as track 154, and configured to move along an entire length of the track 154. According to the exemplary embodiment shown in FIG. 3, track 154 extends along substantially an entire height of body 114 and is configured to cause grabber assembly 152 to tilt near an upper height of body 114. In other embodiments, the track 154 extends along substantially an entire height of body 114 on a rear side of body 114.

As shown in FIG. 3-6, grabber assembly 152 includes a pair of grabber arms, shown as first grabber arm 156 (e.g., right grabber arm, forward grabber arm, etc.) and second grabber arm 158. The first grabber arm 156 and the second grabber arm 158 are each configured to rotate about an axis extending through a bushing. For example, the first grabber arm 156 may rotate about a first axis extending through a first bushing and the second grabber arm 158 may rotate about a second axis extending through a second bushing. The first grabber arm 156 and the second grabber arm 158 are configured to releasably secure a refuse container to grabber assembly 152, according to an exemplary embodiment. For example, the first grabber arm 156 may rotate about the first axis extending through the first bushing and the second grabber arm 158 may rotate about the second axis extending through the second bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the first grabber arm 156 and the second grabber arm 158 are rotated towards each other such that the refuse container is grasped therebetween. In the disengaged state, the first grabber arm 156 and the second grabber arm 158 rotate outwards such that the refuse container is not grasped therebetween. By transitioning between the engaged state and the disengaged state, the first grabber arm 156 and the second grabber arm 158 releasably couples the refuse container with grabber assembly 152. The refuse vehicle 100 may pull up along-side the refuse container, such that the refuse container is positioned to be grasped by the first grabber arm 156 and the second grabber arm 158 therebetween. The first grabber arm 156 and the second grabber arm 158 may then transition into an engaged state to grasp the refuse container. After the refuse container has been securely grasped by the first grabber arm 156 and the second grabber arm 158, the grabber assembly 152 may be transported along track 154 with the refuse container. When the grabber assembly 152 reaches the end of track 154, the grabber assembly 152 may tilt and empty the contents of the refuse container in refuse compartment 130. The tilting is facilitated by the path of the track 154. When the contents of the refuse container have been emptied into refuse compartment 130, the grabber assembly 152 may descend along the track 154, and return the refuse container to the ground. Once the refuse container has been placed on the ground, the first grabber arm 156 and the second grabber arm 158 may transition into the disengaged state, releasing the refuse container.

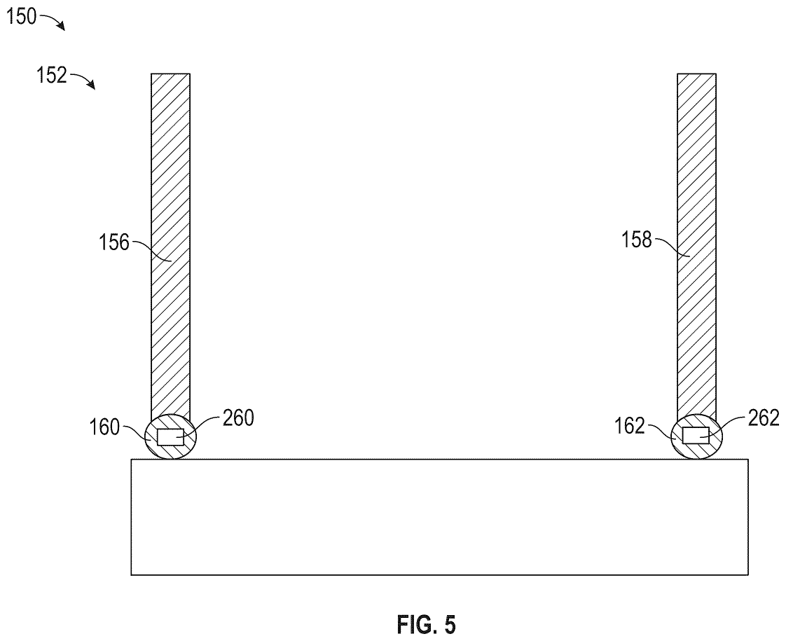

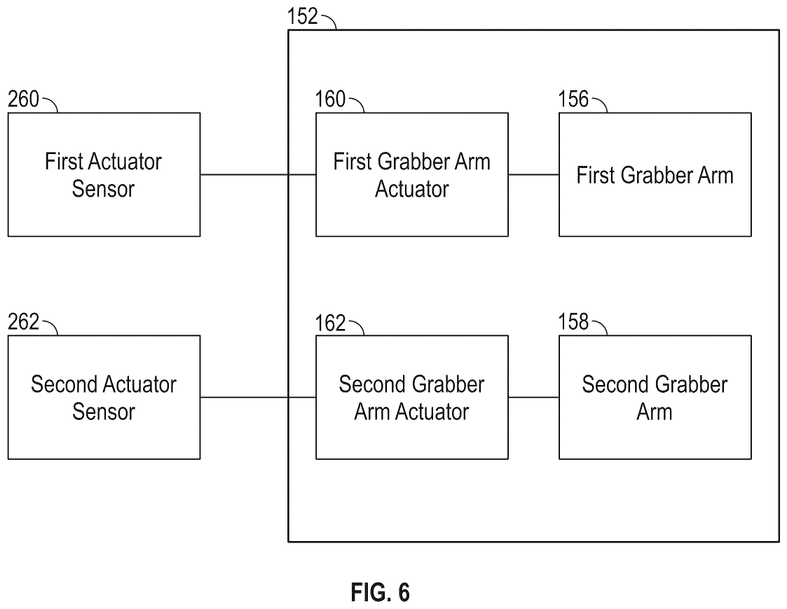

As shown in FIGS. 5 and 6, the grabber assembly 152 includes a first grabber arm actuator 160 (e.g., a first piston, a first motor, etc.) configured to transition the first grabber arm 156 between the engaged state and the disengaged state and a second grabber arm actuator 162 (e.g., a second piston, a second motor, etc.) configured to transition the second grabber arm 158 between the engaged state and the disengaged state. According to an exemplary embodiment, the first grabber arm actuator 160 and the second grabber arm actuator 162 are motors that are rotated to drive the first grabber arm 156 and the second grabber arm 158 between the engaged state and the disengaged state. In other embodiments, the first grabber arm actuator 160 and the second grabber arm actuator 162 are hydraulic pistons that are actuated between extended positions and retracted positions to drive the first grabber arm 156 and the second grabber arm 158 between the engaged state and the disengaged state.

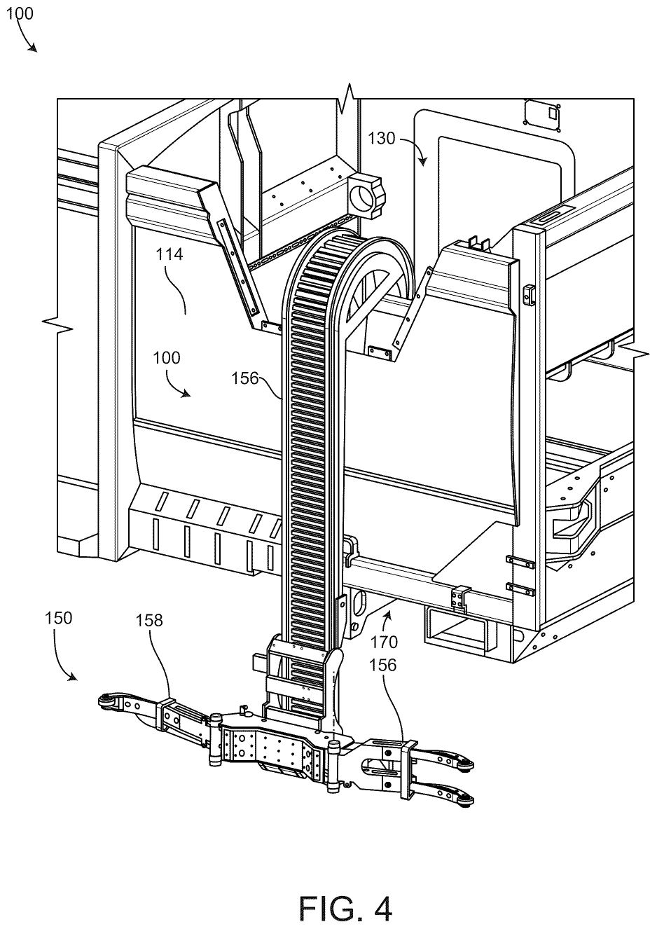

As shown in FIG. 4, the refuse vehicle 100 includes a reach assembly 170 configured to operate to facilitate extension and/or retraction of the grabber assembly 152 and/or the lift assembly 150. The reach assembly 170 may be configured to extend and/or retract from a side (e.g., a lateral side, etc.) of the refuse vehicle 100 to facilitate lateral reach for the grabber assembly 152 to releasably grasp refuse containers that may be positioned a lateral distance from the refuse vehicle 100 (e.g., on a curbside, etc.). For example, the reach assembly 170 may be configured to move between a retracted configuration and an extended configuration to facilitate extension and/or retraction of the grabber assembly 152 and/or the lift assembly 150. In some embodiments, the reach assembly 170 is configured to extend and/or retract to laterally translate the grabber assembly 152 and/or the lift assembly 150. In some embodiments, the reach assembly 170 is configured to extend and/or retract to laterally translate the grabber assembly 152 and a portion of the lift assembly 150 (e.g., a portion of the track 154, etc.). The reach assembly 170 may be coupled to the frame 112 and/or the body 114 of the refuse vehicle 100.

### Control System

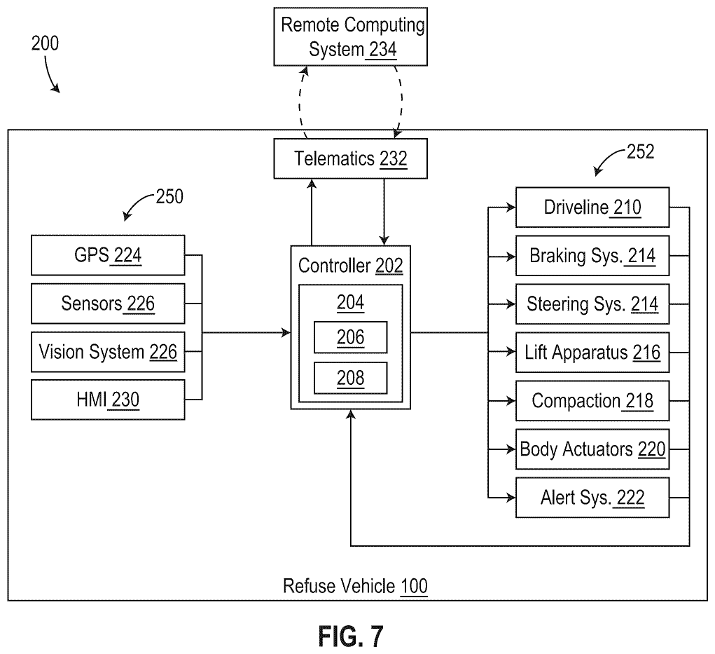

Referring to FIG. 7, the refuse vehicle 100 may include a control system 200 that is configured to facilitate autonomous or semi-autonomous operation of the refuse vehicle 100, or components thereof. The control system 200 includes a controller 202 that is positioned on the refuse vehicle 100, a remote computing system 234, a telematics unit 232, one or more input devices 250, and one or more controllable elements 252. The input devices 250 can include a Global Positioning System (“GPS”), multiple sensors 226, a vision system 228 (e.g., an awareness system), and a Human Machine Interface (“HMI”). The controllable elements 252 can include a driveline 210 of the refuse vehicle 100, a braking system 212 of the refuse vehicle 100, a steering system 214 of the refuse vehicle 100, a lift apparatus 216 (e.g., the lift assembly 140, the lift assembly 150, the reach assembly 170, etc.), a compaction system 218 (e.g., a packer assembly, the packer 146, etc.), body actuators 220 (e.g., tailgate actuators 124, lift or dumping actuators, etc.), and/or an alert system 222.

The controller 202 includes processing circuitry 204 including a processor 206 and memory 208. Processing circuitry 204 can be communicably connected with a communications interface of controller 202 such that processing circuitry 204 and the various components thereof can send and receive data via the communications interface. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to some embodiments, memory 208 is communicably connected to processor 206 via processing circuitry 204 and includes computer code for executing (e.g., by at least one of processing circuitry 204 or processor 206) one or more processes described herein.

The controller 202 is configured to receive inputs (e.g., measurements, detections, signals, sensor data, etc.) from the input devices 250, according to some embodiments. In particular, the controller 202 may receive a GPS location from the GPS system 224 (e.g., current latitude and longitude of the refuse vehicle 100). The controller 202 may receive sensor data (e.g., engine temperature, fuel levels, transmission control unit feedback, engine control unit feedback, speed of the refuse vehicle 100, etc.) from the sensors 226. The controller 202 may receive image data (e.g., real-time camera data) from the vision system 228 of an area of the refuse vehicle 100 (e.g., in front of the refuse vehicle 100, rearwards of the refuse vehicle 100, on a street-side or curb-side of the refuse vehicle 100, at the hopper of the refuse vehicle 100 to monitor refuse that is loaded, within the cab 116 of the refuse vehicle 100, etc.). The controller 202 may receive user inputs from the HMI 230 (e.g., button presses, requests to perform a lifting or loading operation, driving operations, steering operations, braking operations, etc.).

The controller 202 may be configured to provide control outputs (e.g., control decisions, control signals, etc.) to the driveline 210 (e.g., the engine 118, the transmission 122, the engine control unit, the transmission control unit, etc.) to operate the driveline 210 to transport the refuse vehicle 100. The controller 202 may also be configured to provide control outputs to the braking system 212 to activate and operate the braking system 212 to decelerate the refuse vehicle 100 (e.g., by activating a friction brake system, a regenerative braking system, etc.). The controller 202 may be configured to provide control outputs to the steering system 214 to operate the steering system 214 to rotate or turn at least two of the tractive elements 120 to steer the refuse vehicle 100. The controller 202 may also be configured to operate actuators (e.g., motors, etc.) of the lift apparatus 216 (e.g., lift arm actuators 144, the first grabber arm actuator 160, the extension actuator 176, fork actuators associated with forks of the lift assembly 140 to raise and lower tips of the forks of the lift assembly 140, etc.) to perform a lifting operation (e.g., to grasp, lift, empty, and return a refuse container). The controller 202 may also be configured to operate the compaction system 218 to compact or pack refuse that is within the refuse compartment 130. The controller 202 may also be configured to operate the body actuators 220 to implement a dumping operation of refuse from the refuse compartment 130 (e.g., driving the refuse compartment 130 to rotate to dump refuse at a landfill). The controller 202 may also be configured to operate the alert system 222 (e.g., lights, speakers, display screens, etc.) to provide one or more aural or visual alerts to nearby individuals.

The controller 202 may also be configured to receive feedback from any of the driveline 210, the braking system 212, the steering system 214, the lift apparatus 216, the compaction system 218, the body actuators 220, or the alert system 222. The controller 202 may provide any of the feedback to the remote computing system 234 via the telematics unit 232. The telematics unit 232 may include any wireless transceiver, cellular dongle, communications radios, antennas, etc., to establish wireless communication with the remote computing system 234. The telematics unit 232 may facilitate communications with telematics units 232 of nearby refuse vehicles 100 to thereby establish a mesh network of refuse vehicles 100.

The controller 202 is configured to use any of the inputs from any of the GPS system 224, the sensors 226, the vision system 228, or the HMI 230 to generate controls for the driveline 210, the braking system 212, the steering system 214, the lift apparatus 216, the compaction system 218, the body actuators 220, or the alert system 222. In some embodiments, the controller 202 is configured to operate the driveline 210, the braking system 212, the steering system 214, the lift apparatus 216, the compaction system 218, the body actuators 220, and/or the alert system 222 to autonomously transport the refuse vehicle 100 along a route (e.g., self-driving), perform pickups or refuse collection operations autonomously, and transport to a landfill to empty contents of the refuse compartment 130. The controller 202 may receive one or more inputs from the remote computing system 234 such as route data, indications of pickup locations along the route, route updates, customer information, pickup types, etc. The controller 202 may use the inputs from the remote computing system 234 to autonomously transport the refuse vehicle 100 along the route and/or to perform the various operations along the route (e.g., picking up and emptying refuse containers, providing alerts to nearby individuals, limiting pickup operations until an individual has moved out of the way, etc.).

In some embodiments, the remote computing system 234 is configured to interact with (e.g., control, monitor, etc.) the refuse vehicle 100 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 234 may perform any of the route planning techniques as described in greater detail in U.S. application Ser. No. 18/111,137, filed Feb. 17, 2023, the entire disclosure of which is incorporated by reference herein. The remote computing system 234 may implement any route planning techniques based on data received by the controller 202. In some embodiments, the controller 202 is configured to implement any of the cart alignment techniques as described in U.S. application Ser. No. 18/242,224, filed Sep. 5, 2023, the entire disclosure of which is incorporated by reference herein. The refuse vehicle 100 and the remote computing system 234 may also operate or implement geofences as described in greater detail in U.S. application Ser. No. 17/232,855, filed Apr. 16, 2021, the entire disclosure of which is incorporated by reference herein.

### Position Based Control

According to an exemplary embodiment, the controller 202 is configured to compare displacements associated with at least two movable bodies of the lift apparatus 216 and derate a speed of at least one actuator (e.g., the lift arm actuators 144, the fork actuators associated with the forks of the lift assembly 140, etc.) driving the at least two movable bodies of the lift apparatus 216 based on the comparison of the displacements of the movable bodies. For example, when the controller 202 is operating a pair of actuators of the lift apparatus 216 to drive a pair of movable bodies to perform a lifting operation, the controller 202 may operate the pair of actuators with a target speed (e.g., a desired speed, etc.) to drive the pair of movable bodies. However, when a first displacement associated with the first of the movable bodies is greater than a second displacement associated with a second movable body for a given input (and/or when a first of the actuators driving the first of the movable bodies operates with a first actual speed and a second of the actuators driving the second of the movable bodies operates with a second actual speed that is slower than the first actual speed), the movable bodies may be out of synchronization, which can result in issues with operation of the lift apparatus 216 (e.g., stresses in components of the lift apparatus 216, failed operation of the lift apparatus 216, etc.).

The controller 202 may receive sensor data corresponding to the first displacement associated with the first of the movable bodies and the second displacement associated with the second of the movable bodies during operation and, responsive to the first displacement being greater than the second displacement, operate the first of the actuators with a derated speed that is slower than the target speed such that a displacement rate of the first displacement and the second displacement is equalized. For example, the controller 202 may derate a speed of the first grabber arm actuator 160 and/or the second grabber arm actuator 162 based on a comparison of a first displacement of the first grabber arm 156 and a second displacement of the second grabber arm 158 such that the first grabber arm 156 and the second grabber arm 158 are driven by the first grabber arm actuator 160 and the second grabber arm actuator 162, respectively, at a same displacement rate. When the first displacement of the first grabber arm 156 is greater than the second displacement of the second grabber arm 158, the controller 202 may derate the speed of the first grabber arm actuator 160. When the second displacement of the second grabber arm 158 is greater than the first displacement of the first grabber arm 156, the controller 202 may derate the speed of the second grabber arm actuator 162.

In some embodiments, the controller 202 is configured to compare displacements associated with at least two movable bodies of the lift apparatus 216 and derate a speed of at least one of the actuators driving the at least two movable bodies of the lift apparatus 216 when an operator is operating the lift apparatus 216. By way of example, the controller 202 may receive user inputs from the HMI 230 associated with operating the lift apparatus 216 and the controller 202 may operate at least two actuators of the lift apparatus 216 while operating the lift apparatus 216 according to the user inputs. The controller 202 may compare displacements associated with components of the lift apparatus 216 driven by the at least two actuators and may derate a speed of one of the actuators based on the comparison of the displacements. In some embodiments, the controller 202 is configured to compare displacements associated with at least two movable bodies of the lift apparatus 216 and derate a speed of at least one actuator driving the at least two movable bodies of the lift apparatus 216 during autonomous or semi-autonomous operation of the lift apparatus 216. For example, the controller 202 may be configured to autonomously operate the lift apparatus 216 through the lifting operation (e.g., to grasp, lift, empty, and return a refuse container) and the controller 202 may compare displacements associated with components of the lift apparatus 216 driven by the at least two actuators and may derate a speed of one of the actuators based on the comparison of the displacements while autonomously operating the lift apparatus 216 through the lifting operation.

In some embodiments, the controller 202 is configured to compare displacements associated with at least two movable bodies of the lift apparatus 216 and derate a speed of at least one of the actuators driving the at least two movable bodies of the lift apparatus 216 when speed derating is enabled. When the speed derating is enabled, the controller 202 may be allowed to derate the speed of actuators of the lift apparatus 216. When the speed derating is disabled, the controller 202 may be prohibited from derating the speed of the actuators of the lift apparatus 216. By way of example, the HMI 230 may include a derate interface (e.g., a button, a switch, etc.) associated with derating the speed of the actuators of the lift apparatus 216. The HMI 230 may provide a user input to the controller 202 based on operator interactions with the derate interface that correspond with enabling or disabling derating the speed of the actuators of the lift apparatus 216 to allow or prohibit the controller 202 from derating the speed of the actuators of the lift apparatus 216.

In some embodiments, the controller 202 is configured to derate a speed of at least one of the actuators driving components of the lift apparatus 216 based on displacement data (e.g., positional data, etc.) corresponding to displacements (e.g., positions, etc.) associated with the components of the lift apparatus 216 received from at least one of the sensors 226. For example, the controller 202 may operate a first actuator of the lift apparatus 216 and a second actuator of the lift apparatus 216 associated with the first actuator with a target speed, receive first displacement data from at least one of the sensors 226 corresponding to a first displacement associated with the first actuator, receive second displacement data from at least one of the sensors 226 corresponding to a second displacement associated with the second actuator, and, responsive to the first displacement being greater than the second displacement, operate the first actuator with a derated speed that is slower than the target speed. In various embodiments, the controller 202 is configured to derate a speed of other actuators of the refuse vehicle 100 (e.g., actuators of the driveline 210, actuators of the steering system 214, actuators of the compaction system 218, the body actuators, etc.). For example, the controller 202 may derate the speed of the other actuators of the refuse vehicle 100 based on comparisons of displacements of corresponding movable bodies of the refuse vehicle. The controller 202 may compare the displacements of the movable bodies of the refuse vehicle 100 based on displacement data acquired from the sensors 226 of the refuse vehicle 100 corresponding to the displacements of the movable bodies of the refuse vehicle 100.

As shown in FIGS. 5 and 6, at least one of the sensors 226 is configured as a first grabber arm sensor 260 configured to generate first displacement data (e.g., first sensor data, etc.) corresponding to a first displacement associated with the first grabber arm 156. The first displacement data include the first displacement associated with the first grabber arm 156, a first displacement rate relating to the first displacement associated with the first grabber arm 156, etc. For example, the first grabber arm sensor 260 may be configured to generate first displacement data corresponding to a first displacement of the first grabber arm 156 from the disengaged state of the first grabber arm 156. As another example, the first grabber arm sensor 260 may be configured to generate first displacement data corresponding to a first displacement of the first grabber arm 156 from the engaged state of the first grabber arm 156.

According to the exemplary embodiment shown in FIGS. 5 and 6, the first grabber arm sensor 260 is an encoder configured to generate first displacement data corresponding to the first displacement of the first grabber arm 156 based on operation of the first grabber arm actuator 160. By way of example, when the first grabber arm actuator 160 is a motor, the first grabber arm sensor 260 may be a rotational encoder that is rotated as the first grabber arm actuator 160 rotates to drive (e.g., move, etc.) the first grabber arm 156 between the engaged state and the disengaged state. The first grabber arm sensor 260 may count a number of rotations of the first grabber arm actuator 160 and generate the first displacement data corresponding to the first displacement of the first grabber arm 156 based on the number of rotations (e.g., first movement of the first grabber arm actuator 160, etc.). By way of another example, when the first grabber arm actuator 160 is configured as a linear actuator, the first grabber arm sensor 260 may be a linear encoder that measures actuation distances of the first grabber arm actuator 160 as the first grabber arm actuator 160 actuates to drive the first grabber arm 156 between the engaged state and the disengaged state. The first grabber arm sensor 260 may determine the actuation distance of the first grabber arm actuator 160 and generate the first displacement data corresponding to the first displacement of the first grabber arm 156 based on the actuation distance of the first grabber arm actuator 160. In other embodiments, the first grabber arm sensor 260 is another type of sensor (e.g., a strain sensor, etc.) configured to generate first displacement data corresponding to the first displacement associated with the first grabber arm 156. By way of example, the first grabber arm sensor 260 may be a distance sensor (e.g., an ultrasonic sensor, an infrared sensor, a camera, etc.) configured to generate the first displacement data corresponding to the first displacement associated with the first grabber arm 156 based on a distance between the first grabber arm sensor 260 and a portion of the first grabber arm 156. By way of another example, the first grabber arm sensor 260 may be a first inverter electrically coupled between a battery of the refuse vehicle 100 and the first grabber arm actuator 160 configured to generate first electrical data corresponding to the first displacement associated with the first grabber arm 156.

As shown in FIGS. 5 and 6, at least one of the sensors 226 is configured as a second grabber arm sensor 262 configured to generate second displacement data (e.g., second sensor data, etc.) corresponding to a second displacement associated with the second grabber arm 158. The second displacement data include the second displacement associated with the second grabber arm 158, a second displacement rate relating to the second displacement associated with the second grabber arm 158, etc. For example, the second grabber arm sensor 262 may be configured to generate second displacement data corresponding to a second displacement of the second grabber arm 158 from the disengaged state of the second grabber arm 158. As another example, the second grabber arm sensor 262 may be configured to generate second displacement data corresponding to a second displacement of the second grabber arm 158 from the engaged state of the second grabber arm 158. In other embodiments, at least one of the sensors 226 is configured as a grabber arm sensor configured to generate combined displacement data corresponding to the first displacement associated with the first grabber arm 156 and the second displacement associated with the second grabber arm 158.

According to the exemplary embodiment shown in FIGS. 5 and 6, the second grabber arm sensor 262 is an encoder configured to generate second displacement data corresponding to the second displacement of the second grabber arm 158 based on operation of the second grabber arm actuator 162. By way of example, when the second grabber arm actuator 162 is a motor, the second grabber arm sensor 262 may be a rotational encoder that is rotated as the second grabber arm actuator 162 rotates to drive (e.g., move, etc.) the second grabber arm 158 between the engaged state and the disengaged state. The second grabber arm sensor 262 may count a number of rotations of the second grabber arm actuator 162 and generate the second displacement data corresponding to the second displacement of the second grabber arm 158 based on the number of rotations (e.g., second movement of the second grabber arm actuator 162, etc.). By way of another example, when the second grabber arm actuator 162 is configured as a linear actuator, the second grabber arm sensor 262 may be a linear encoder that measures actuation distances of the second grabber arm actuator 162 as the second grabber arm actuator 162 actuates to drive the second grabber arm 158 between the engaged state and the disengaged state. The second grabber arm sensor 262 may determine the actuation distance of the second grabber arm actuator 162 and generate the second displacement data corresponding to the second displacement of the second grabber arm 158 based on the actuation distance of the second grabber arm actuator 162. In other embodiments, the second grabber arm sensor 262 is another type of sensor (e.g., a strain sensor, etc.) configured to generate second displacement data corresponding to the second displacement associated with the second grabber arm 158. By way of example, the second grabber arm sensor 262 may be a distance sensor (e.g., an ultrasonic sensor, an infrared sensor, a camera, etc.) configured to generate the second displacement data corresponding to the second displacement associated with the second grabber arm 158 based on a distance between the second grabber arm sensor 262 and a portion of the second grabber arm 158. By way of another example, the second grabber arm sensor 262 may be a second inverter electrically coupled between a battery of the refuse vehicle 100 and the second grabber arm actuator 162 configured to generate second electrical data corresponding to the second displacement associated with the second grabber arm 158.

According to an exemplary embodiment, the controller 202 is configured to derate (e.g., slow down, etc.) a speed of the first grabber arm actuator 160 and/or the second grabber arm actuator 162 based on the first displacement data acquired from the first grabber arm sensor 260 and the second displacement data acquired from the second grabber arm sensor 262. For example, the controller 202 may begin by operating the first grabber arm actuator 160 and the second grabber arm actuator 162 with a target speed (e.g., a maximum operating speed, a desired speed, etc.). While operating the first grabber arm actuator 160 and the second grabber arm actuator 162 with the target speed, the controller 202 may receive the first displacement data from the first grabber arm sensor 260 associated with the first displacement of the first grabber arm 156 and the second displacement data from the second grabber arm sensor 262 associated with the second displacement of the second grabber arm 158. The controller 202 may compare the first displacement data and the second displacement data to determine if the first displacement associated with the first grabber arm 156 is greater, less than, or equal to the second displacement associated with the second grabber arm 158. When the first displacement associated with the first grabber arm 156 is greater than the second displacement associated with the second grabber arm 158, the controller 202 may operate the first grabber arm actuator 160 with a derated speed (e.g., a slower speed, etc.) that is slower than the target speed. When the second displacement associated with the second grabber arm 158 is greater than the first displacement associated with the first grabber arm 156, the controller 202 may operate the second grabber arm actuator 162 with a derated speed that is slower than the target speed. When the first displacement associated with the first grabber arm 156 is equal to the second displacement associated with the second grabber arm 158, the controller 202 may continue to operate the first grabber arm actuator 160 and the second grabber arm actuator 162 with the target speed.

The controller 202 may derate the speed of the first grabber arm actuator 160 and/or the second grabber arm actuator 162 by generating an updated control signal corresponding to the derated speed and providing the updated control signal to the lift apparatus 216. By way of example, when the first grabber arm actuator 160 and the second grabber arm actuator 162 are electric motors, the controller 202 may derate the speed of the first grabber arm actuator 160 and/or the second grabber arm actuator 162 by generating an updated control signal corresponding to supplying a lower amount of power to the first grabber arm actuator 160 and/or the second grabber arm actuator 162 in order to derate the speed of the first grabber arm actuator 160 and/or the second grabber arm actuator 162. The controller 202 may supply the updated control signal to a controller configured to control an amount of power provided to the first grabber arm actuator 160 and/or the second grabber arm actuator 162 in order to derate the speed of the first grabber arm actuator 160 and/or the second grabber arm actuator 162. By way of another example, when the first grabber arm actuator 160 and the second grabber arm actuator 162 are separately actuated hydraulic actuators, the controller 202 may derate the speed of the first grabber arm actuator 160 and/or the second grabber arm actuator 162 by generating an updated control signal corresponding to reducing a flow rate of hydraulic fluid provided to the first grabber arm actuator 160 and/or the second grabber arm actuator 162. The controller 202 may provide the updated control signal to a first hydraulic valve configured to control a first flow rate of the hydraulic fluid to the first grabber arm actuator 160 and/or to a second hydraulic valve configured to control a second flow rate of the hydraulic fluid to the second grabber arm actuator 162 in order to derate the speed of the first grabber arm actuator 160 and/or the second grabber arm actuator 162.

In some embodiments, the controller 202 is configured to derate the speed of the first grabber arm actuator 160 and/or the second grabber arm actuator 162 when a difference between the first displacement associated with the first grabber arm actuator 160 and the second displacement associated with the second grabber arm actuator 162 is greater than a displacement threshold. For example, the controller 202 may acquire the first displacement data from the first grabber arm sensor 260 and the second displacement data from the second grabber arm sensor 262. The controller 202 may calculate a difference between the first displacement associated with the first grabber arm actuator 160 and the second displacement associated with the second grabber arm actuator 162 based on the first displacement data and the second displacement data. When the difference between the first displacement associated with the first grabber arm actuator 160 and the second displacement associated with the second grabber arm actuator 162 is greater than a displacement threshold, the controller 202 may derate the speed of the first grabber arm actuator 160 and/or the second grabber arm actuator 162. When the difference between the first displacement associated with the first grabber arm actuator 160 and the second displacement associated with the second grabber arm actuator 162 is less than or equal to the displacement threshold, the controller 202 may continue to operate the first grabber arm actuator 160 and/or the second grabber arm actuator 162 with the target speed.

In some embodiments, the controller 202 is configured to derate the speed of the first grabber arm actuator 160 and/or the second grabber arm actuator 162 when the speed of the first grabber arm actuator 160 and/or the second grabber arm actuator 162 is greater than a speed threshold. For example, the controller 202 may begin by operating the first grabber arm actuator 160 and the second grabber arm actuator 162 with the target speed. When the target speed is greater than the speed threshold, the controller 202 may acquire the first displacement data from the first grabber arm sensor 260 and the second displacement data from the second grabber arm sensor 262 and determine whether to derate the speed of the first grabber arm actuator 160 and/or the second grabber arm actuator 162. When the target speed is less than or equal to the speed threshold, the controller 202 may continue to operate the first grabber arm actuator 160 and/or the second grabber arm actuator 162 with the target speed.

In some embodiments, the controller 202 is configured to operate the first grabber arm actuator 160 and/or the second grabber arm actuator 162 with a minimum operating speed instead of the derated speed when the derated speed is less than the minimum operating speed. The minimum operating speed of the first grabber arm actuator 160 and/or the second grabber arm actuator 162 may be equal to the speed threshold. For example, the controller 202 may acquire the first displacement data from the first grabber arm sensor 260 and the second displacement data from the second grabber arm sensor 262 and may determine a derated speed for the first grabber arm actuator 160 and/or the second grabber arm actuator 162 based on the first displacement data and the second displacement data. However, when the derated speed is less than the minimum operating speed, the controller 202 may operate the first grabber arm actuator 160 and/or the second grabber arm actuator 162 with the minimum operating speed instead of the derated speed.

In some embodiments, the controller 202 is configured to up-rate (e.g., speed up, etc.) a speed of the first grabber arm actuator 160 and/or the second grabber arm actuator 162 based on the first displacement data acquired from the first grabber arm sensor 260 and the second displacement data acquired from the second grabber arm sensor 262. For example, the controller 202 may begin by operating the first grabber arm actuator 160 and the second grabber arm actuator 162 with a target speed (e.g., a maximum operating speed, a desired speed, etc.). While operating the first grabber arm actuator 160 and the second grabber arm actuator 162 with the target speed, the controller 202 may receive the first displacement data from the first grabber arm sensor 260 associated with the first displacement of the first grabber arm 156 and the second displacement data from the second grabber arm sensor 262 associated with the second displacement of the second grabber arm 158. The controller 202 may compare the first displacement data and the second displacement data to determine if the first displacement associated with the first grabber arm 156 is greater, less than, or equal to the second displacement associated with the second grabber arm 158. When the first displacement associated with the first grabber arm 156 is greater than the second displacement associated with the second grabber arm 158, the controller 202 may operate the second grabber arm actuator 162 with an up-rated speed that is faster than the target speed. When the second displacement associated with the second grabber arm 158 is greater than the first displacement associated with the first grabber arm 156, the controller 202 may operate the first grabber arm actuator 160 with an up-rated speed (e.g., a faster speed, a boosted speed, etc.) that is faster than the target speed. When the first displacement associated with the first grabber arm 156 is equal to the second displacement associated with the second grabber arm 158, the controller 202 may continue to operate the first grabber arm actuator 160 and the second grabber arm actuator 162 with the target speed.

In some embodiments, the controller 202 is configured to operate the first grabber arm actuator 160 and/or the second grabber arm actuator 162 with a maximum operating speed instead of the up-rated speed when the up-rated speed is greater than the maximum operating speed. For example, the controller 202 may acquire the first displacement data from the first grabber arm sensor 260 and the second displacement data from the second grabber arm sensor 262 and may determine an up-rated speed for the first grabber arm actuator 160 and/or the second grabber arm actuator 162 based on the first displacement data and the second displacement data. However, when the up-rated speed is greater than the maximum operating speed, the controller 202 may operate the first grabber arm actuator 160 and/or the second grabber arm actuator 162 with the maximum operating speed instead of the up-rated speed.

In some embodiments, the controller 202 is configured to determine the derated speed for the first grabber arm actuator 160 and/or the second grabber arm actuator 162 by multiplying the target speed of the first grabber arm actuator 160 and/or the second grabber arm actuator 162 by a derating factor (e.g., a speed factor, etc.). The controller 202 may determine the derating factor based on the comparison of the first displacement data corresponding to the first displacement of the first grabber arm 156 and the second displacement data corresponding to the second displacement of the second grabber arm 158. By way of example, the controller 202 may determine a first displacement rate of the first displacement of the first grabber arm 156 (e.g., a derivative of the first displacement, etc.) and a second displacement rate of the second displacement of the second grabber arm 158 (e.g., a derivative of the second displacement, etc.). The controller 202 may determine the derating factor for the first grabber arm actuator 160 and/or the second grabber arm actuator 162 based on the first displacement rate and the second displacement rate. For example, controller 202 may determine the derating factor of the first grabber arm actuator 160 and/or the second grabber arm actuator 162 by calculating a ratio between the first displacement rate and the second displacement rate. The ratio may be equal to the slower of the first displacement rate and the second displacement rate divided by the faster of the first displacement rate and the second displacement rate in order to determine the derating factor for the first grabber arm actuator 160 and/or the second grabber arm actuator 162 that will cause the first displacement rate and the second displacement rate to be equal. In other embodiments, the first displacement data includes the first displacement rate of the first displacement and the second displacement data includes the second displacement rate of the second displacement.

In some embodiments, the controller 202 is configured to determine the derated speed for the first grabber arm actuator 160 and/or the second grabber arm actuator 162 by subtracting a derating adjustment from the target speed. The controller 202 may determine the derating adjustment based on the comparison of the first displacement data corresponding to the first displacement of the first grabber arm 156 and the second displacement data corresponding to the second displacement of the second grabber arm 158. By way of example, the controller 202 may take an absolute value of a difference between the first displacement of the first grabber arm 156 and the second displacement of the second grabber arm 158. The controller 202 may determine the derating adjustment by multiplying the absolute value of the difference by a predetermined difference multiplier and may subtract the derating adjustment from the target speed to determine the derated speed that will cause a first displacement rate of the first displacement of the first grabber arm 156 and a second displacement rate of the second displacement of the first grabber arm 156 to be equal.

In some embodiments, the controller 202, prior to operating the first grabber arm actuator 160 and/or the second grabber arm actuator 162 with the derated speed, the controller 202 is configured to operate the first grabber arm actuator 160 and/or the second grabber arm actuator 162 to cause the first displacement of the first grabber arm 156 to equal (e.g., substantially equal, be within 95% to 105% of, etc.) the second displacement of the second grabber arm 158 such that both the first displacement and the second displacement are equal and the first displacement rate and the second displacement rate are equal to further synchronize the first grabber arm 156 and the second grabber arm 158. For example, the controller 202 may receive the first displacement data from the first grabber arm sensor 260 and the second displacement from the second grabber arm sensor 262. When the first displacement associated with the first grabber arm 156 is greater than the second displacement associated with the second grabber arm 158, the controller 202 may determine a derated speed for the first grabber arm actuator 160. However, prior to operating the first grabber arm actuator 160 with the derated speed, the controller 202 may operate the first grabber arm actuator 160 with a speed slower than the derated speed and/or stop operation of the first grabber arm actuator 160 until the second displacement of the second grabber arm 158 is equal to the first displacement of the first grabber arm 156. Once the second displacement of the second grabber arm 158 is equal to the first displacement of the first grabber arm 156, the controller 202 may operate the first grabber arm actuator 160 with the derated speed and the second grabber arm actuator 162 with the target speed to cause the first displacement of the first grabber arm 156 to be equal to the second displacement of the second grabber arm 158 and the first displacement rate of the first grabber arm 156 to be equal to the second displacement rate of the second grabber arm 158 to further synchronize the first grabber arm 156 and the second grabber arm 158.

### Method of Actuator Synchronization

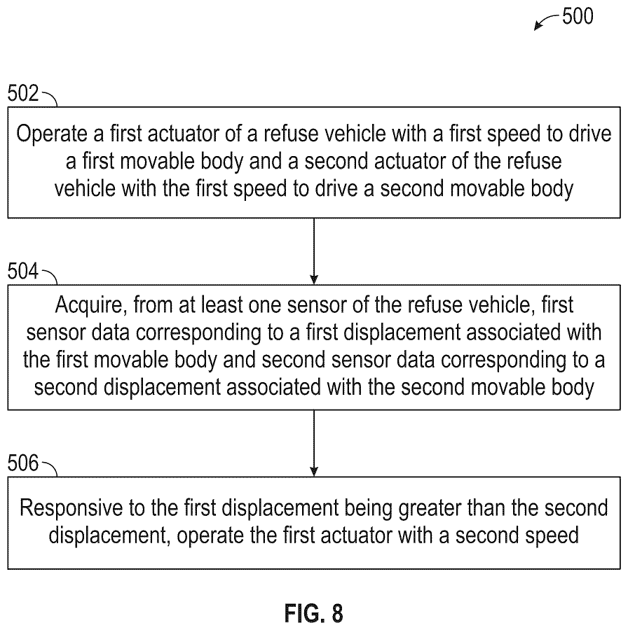

As shown in FIG. 8, a method 500 for operating at least two actuators of a vehicle includes steps 502-506. The two actuators of the vehicle may be configured to drive corresponding movable bodies (e.g., components, etc.) of the vehicle. The method 500 may be executed by, for example, the controller 202 of the refuse vehicle 100. Further, any computing device described herein can be configured to perform at least a portion of the method 500 (e.g., the controller 202, the remote computing system 234, etc.). According to an exemplary embodiment, the method 500 is for operating at least two actuators of a lift system of a refuse vehicle based on displacements associated with at least two corresponding movable bodies driven by the actuators. By way of example, a first actuator may drive a first movable body and a second actuator may drive a second movable body that corresponds to the first movable body. The method 500 may be utilized to operate the first actuator and the second actuator based on comparing a first displacement associated with the first movable body and a second displacement associated with the second movable body such that a first displacement rate of the first movable body is synchronized with a second displacement rate of the second movable body.

As shown in FIG. 8, the method 500 begins with operating a first actuator of a refuse vehicle with a first speed to drive a first movable body and a second actuator of the refuse vehicle with the first speed to drive a second movable body at step 502. In some embodiments, the first movable body corresponds with the second movable body. For example, the first movable body may be a first lift arm of the refuse vehicle and the second movable body may be a second lift arm of the refuse vehicle. The first lift arm and the second lift arm may be configured to be driven in synchronization. In some embodiments, the first speed may be a target speed (e.g., a desired speed, etc.) of operation of the first actuator and the second actuator. The first actuator and the second actuator may be actuators of the lift apparatus 216 (e.g., the lift arm actuators 144, the first grabber arm actuator 160 and the second grabber arm actuator 162, etc.) of the refuse vehicle 100 and the first movable body and the second movable body may be components of the lift apparatus 216 that are driven by the actuators of the lift apparatus 216. For example, step 502 may include operating the first grabber arm actuator 160 of the lift assembly 150 of the refuse vehicle 100 with a first speed to drive the first grabber arm 156 and the second grabber arm actuator 162 of the lift assembly 150 with the first speed to drive the second grabber arm 158.

As shown in FIG. 8, the method 500 includes acquiring, from at least one sensor of the refuse vehicle, first sensor data corresponding to a first displacement associated with the first movable body and second sensor data corresponding to a second displacement associated with the second movable body at step 504. In some embodiments, the first sensor data is acquired from a first sensor of the refuse vehicle associated with the first movable body and the second sensor data is acquired from a second sensor of the refuse vehicle associated with the second movable body. For example, the first sensor may generate first displacement data corresponding to a first displacement of a first component of a lift system of a refuse vehicle and the second sensor may generate second displacement data corresponding to a second displacement of a second component of the lift system of the refuse vehicle, the second component corresponding to the first component. The controller 202 may acquire the first displacement data corresponding to the first displacement associated with the first grabber arm 156 from the first grabber arm actuator 160 and the second displacement data corresponding to the second displacement associated with the second grabber arm 158 from the second grabber arm actuator 162.

As shown in FIG. 8, the method 500 includes, responsive to the first displacement being greater than the second displacement, operating the first actuator with a second speed at step 506. In some embodiments, the second speed is slower than the first speed such that the speed of the first actuator is derated when the first displacement associated with the first actuator is greater than the second displacement associated with the second actuator. For example, responsive to the first displacement being greater than the second displacement, the first actuator may be operated with a derated speed that is slower than the target speed that the first actuator and the second actuator were operated with at step 502. In some embodiment, prior to operating the first actuator with the second speed, the method may include operating the first actuator with a third speed that is slower than the second speed. Once the second displacement associated with the second movable object is equal to the first displacement associated with the first movable object, the first actuator may be operated with the second speed such that the first displacement associated with the first moveable object is equal to the second displacement associated with the second movable object and the first displacement rate associated with the first movable object is equal the second displacement rate associated with the second movable object to further synchronize the displacement of the first moveable object and the second movable object. The controller 202 may operate the first grabber arm actuator 160 with the second speed while operating the second grabber arm actuator 162 with the first speed such that a first displacement rate of the first grabber arm 156 is equal to a second displacement rate of the second grabber arm 158. For example, the controller 202 may operate the first grabber arm actuator 160 with a derated speed that causes the first displacement rate of the first grabber arm 156 to be equal to the second displacement rate of the second grabber arm 158 while the second grabber arm actuator 162 is operated with the target speed.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body coupled to the chassis;
a lift apparatus coupled to at least one of the chassis or the body and configured to collect refuse, the lift apparatus comprising:
a first movable body;
a first actuator configured to move the first movable body;
a second movable body associated with the first movable body; and
a second actuator configured to move the second movable body;
one or more sensors configured to generate sensor data associated with a first displacement of the first movable body and a second displacement of the second movable body; and
one or more processing circuits communicably coupled to the one or more sensors, the one or more processing circuits configured to:
operate the first actuator and the second actuator with a first speed;
acquire, from the one or more sensors, the sensor data; and
responsive to a difference between the first displacement of the first movable body and the second displacement of the second movable body being greater than a difference threshold, operate the first actuator or the second actuator with a second speed, the second speed different from the first speed.

2. The refuse vehicle of claim 1, wherein, prior to operating the first actuator or the second actuator with the second speed, the one or more processing circuits configured to:
operate at least one of the first actuator or the second actuator such that the first displacement of the first movable body is substantially equal to the second displacement of the second movable body.

3. The refuse vehicle of claim 1, wherein, when the first displacement of the first movable body is greater than the second displacement of the second movable body, the one or more processing circuits configured to operate the first actuator with the second speed, the second speed slower than the first speed.

4. The refuse vehicle of claim 1, wherein, prior to operating the first actuator or the second actuator with the second speed, the one or more processing circuits configured to:
determine, based on the sensor data, a first displacement rate of the first movable body and a second displacement rate of the second movable body;
determine, based on the first displacement rate of the first movable body and the second displacement rate of the second movable body, a speed factor; and
determine the second speed by multiplying the first speed by the speed factor.

5. The refuse vehicle of claim 1, wherein, prior to operating the first actuator or the second actuator with the second speed, the one or more processing circuits configured to:
determine the second speed by adjusting the first speed by the difference between the first displacement of the first movable body and the second displacement of the second movable body multiplied by an adjustment factor.

6. The refuse vehicle of claim 1, wherein the lift apparatus includes a grabber mechanism configured to grab a refuse container, the grabber mechanism including the first movable body as a first grabber arm, the second movable body as a second grabber arm, and the first actuator and the second actuator as grabber actuators to facilitate opening and closing the first grabber arm and the second grabber arm to grab the refuse container.

7. The refuse vehicle of claim 1, wherein the lift apparatus includes a lift arm assembly and a fork mechanism coupled to the lift arm assembly, the fork mechanism configured to engage a refuse container, the fork mechanism including the first movable body as a first fork pivotally coupled to the lift arm assembly, the second movable body as a second fork pivotally coupled to the lift arm assembly, and the first actuator and the second actuator as fork actuators to facilitate raising and lowering tips of the first fork and the second fork relative to the lift arm assembly to align the tips of the first fork and the second fork relative to the refuse container.

8. The refuse vehicle of claim 1, wherein the lift apparatus includes a lift arm assembly including the first movable body as a first lift arm pivotally coupled to the at least one of the chassis or the body, the second movable body as a second lift arm pivotally coupled to the at least one of the chassis or the body, and the first actuator and the second actuator as lift arm actuators to facilitate pivoting the first lift arm and the second lift arm relative to the at least one of the chassis or the body.

9. The refuse vehicle of claim 1, wherein the one or more sensors include:
a first encoder configured to measure first movement associated with the first actuator corresponding to the first displacement of the first movable body; and
a second encoder configured to measure second movement associated with the second actuator corresponding to the second displacement of the second movable body.

10. The refuse vehicle of claim 1, wherein:
the one or more sensors include one or more cameras configured to generate image data corresponding to the first movable body and the second movable body; and
the one or more processing circuits are configured to determine the difference between the first displacement of the first movable body and the second displacement of the second movable body based on the image data.

11. A refuse vehicle comprising:
a chassis;
a body coupled to the chassis;
a lift apparatus coupled to at least one of the chassis or the body and configured to collect refuse, the lift apparatus comprising:
a first movable body;
a first actuator configured to move the first movable body;
a second movable body associated with the first movable body; and
a second actuator configured to move the second movable body;
a first sensor configured to generate first sensor data associated with a first displacement of the first movable body;
a second sensor configured to generate second sensor data associated with a second displacement of the second movable body; and
one or more processing circuits communicably coupled to the first sensor and the second sensor, the one or more processing circuits configured to:
operate the first actuator and the second actuator with a first speed;
acquire, from the first sensor, the first sensor data;
acquire, from the second sensor, the second sensor data; and
responsive to the first displacement of the first movable body being greater than the second displacement of the second movable body, operate the first actuator with a second speed, the second speed slower than the first speed.

12. The refuse vehicle of claim 11, wherein, prior to operating the first actuator with the second speed, the one or more processing circuits configured to:
operate the second actuator such that the second displacement of the second movable body is substantially equal to the first displacement of the first movable body.

13. The refuse vehicle of claim 12, wherein, while operating the second actuator such that the second displacement of the second movable body is substantially equal to the first displacement of the first movable body, the one or more processing circuits are configured to operate the first actuator with a third speed, the third speed slower than the second speed.

14. The refuse vehicle of claim 11, wherein the lift apparatus includes a grabber mechanism configured to grab a refuse container, the grabber mechanism including the first movable body as a first grabber arm, the second movable body as a second grabber arm, and the first actuator and the second actuator as grabber actuators to facilitate opening and closing the first grabber arm and the second grabber arm to grab the refuse container.

15. The refuse vehicle of claim 11, wherein the lift apparatus includes a lift arm assembly and a fork mechanism coupled to the lift arm assembly, the fork mechanism configured to engage a refuse container, the fork mechanism including the first movable body as a first fork pivotally coupled to the lift arm assembly, the second movable body as a second fork pivotally coupled to the lift arm assembly, and the first actuator and the second actuator as fork actuators to facilitate raising and lowering tips of the first fork and the second fork relative to the lift arm assembly to align the tips of the first fork and the second fork relative to the refuse container.

16. The refuse vehicle of claim 11, wherein the lift apparatus includes a lift arm assembly including the first movable body as a first lift arm pivotally coupled to the at least one of the chassis or the body, the second movable body as a second lift arm pivotally coupled to the at least one of the chassis or the body, and the first actuator and the second actuator as lift arm actuators to facilitate pivoting the first lift arm and the second lift arm relative to the at least one of the chassis or the body.

17. The refuse vehicle of claim 11, wherein:
the first sensor is a first encoder configured to measure first movement associated with the first actuator corresponding to the first displacement of the first movable body; and
the second sensor is a second encoder configured to measure second movement associated with the second actuator corresponding to the second displacement of the second movable body.

18. A method of operating a plurality of corresponding actuators of a refuse vehicle, the method comprising:
operating a first actuator of the plurality of corresponding actuators with a first speed to move a first movable body;
operating a second actuator of the plurality of corresponding actuators with a second speed to move a second movable body;
acquiring, from one or more sensors associated with the plurality of corresponding actuators, sensor data associated with a first displacement of the first movable body and a second displacement of the second movable body; and
responsive to a difference between the first displacement of the first movable body and the second displacement of the second movable body being greater than a difference threshold, operating the first actuator or the second actuator with a second speed, the second speed different from the first speed.

19. The method of claim 18, wherein, prior to operating the first actuator or the second actuator with the second speed, the method comprises:
operating at least one of the first actuator or the second actuator at a third speed such that the first displacement of the first movable body is substantially equal to the second displacement of the second movable body, the third speed different from the first speed and the second speed.

20. The method of claim 18, wherein, when the first displacement of the first movable body is greater than the second displacement of the second movable body, the first actuator is operated with the second speed, the second speed slower than the first speed.
